(19) United States
(12) Patent Application Publication
(10) Pub. No.: US 2025/0133310 A1
(43) Pub. Date: Apr. 24, 2025

(54) SYSTEM AND METHOD FOR EXTENDING THE FUNCTIONALITY OF A FIRST TRANSMITTER

(71) Applicant: Endress+Hauser Conducta GmbH+Co. KG, Gerlingen (DE)

(72) Inventors: Roman Griesser, Gerlingen (DE); Benjamin Haid, Ammerbuch (DE); Richard Montbrun, Wiernsheim (DE)

(21) Appl. No.: 18/912,653

(22) Filed: Oct. 11, 2024

(30) Foreign Application Priority Data
Oct. 18, 2023 (DE) 10 2023 128 594.7

(51) Int. Cl. H04Q 9/00

(52) U.S. Cl. CPC H04Q 9/00

(57) ABSTRACT

A measuring system comprises a first transmitter and a second transmitter. First sensors are connected to the first transmitter, and the first transmitter is designed to receive and process first data from the first sensors. Second sensors are connected to the second transmitter, and the second transmitter is designed to receive and process second data from the second sensors The two transmitters are wirelessly in communication with one another. The first transmitter is designed to transfer at least a portion of the first data to the second transmitter and the second transmitter is designed to output and/or process the transferred first data, and/or the second transmitter is designed to transfer at least a portion of the second data to the first transmitter and the first transmitter.

### CROSS-REFERENCE TO RELATED APPLICATION

The present application is related to and claims the priority benefit of German Patent Application No. 10 2023 128 594.7, filed on Oct. 18, 2023, the entire contents of which are incorporated herein by reference.

### TECHNICAL FIELD

The present disclosure relates to a system comprising a first transmitter and a second transmitter, wherein one or more first sensors are connected to the first transmitter, wherein the first transmitter is designed to receive and process first data from the first sensors, wherein one or more second sensors are connected to the second transmitter, wherein the second transmitter is designed to receive and process second data from the second sensors, wherein the first transmitter and the second transmitter are wirelessly in communication connection with one another. Furthermore, the present disclosure relates to a method for extending the functionality of a first transmitter, wherein one or more first sensors are connected to the first transmitter, wherein the first transmitter is designed to receive and process first data from the first sensors.

### BACKGROUND

In process control engineering, sensors are positioned in an environment in order to measure its physical and/or chemical properties. The sensors are, for example, pH sensors, conductivity sensors, turbidity sensors, oxygen sensors, etc. A transmitter, also known as a measuring transducer, is located in the region of the sensor, which transmitter converts and processes the sensor signal. The sensor and the transmitter form a measuring chain, which in connection with the present disclosure is understood to mean a transfer path of a primary sensor signal, which depends on a parameter to be measured, to a unit downstream of the sensor, wherein the downstream unit receives the sensor signal or a processed sensor signal in order to process it further or to react to it. Analyzers as a special form of transmitter are designed to ascertain values by means of extraction methods.

A transmitter in the liquid analysis environment can read sensor values, forward them to control centers and display them. By means of transmitters, measured values can be ascertained at various points in the process. The transmitters are placed close to the measuring sensors so that the sensors can be connected to the corresponding transmitter. The values collected by a plurality of transmitters are then combined at a control center. Apps that run on mobile devices such as smartphones or tablets can also assume a control center function. The applicant offers an app under the name “SmartBlue,” which can display and process data transmitted by the transmitters via Bluetooth to a mobile device.

Only a limited number of sensors can be connected to transmitters.

In addition, the transmitters are limited in the physical interfaces to the sensors, the control center and operating/display elements such as menus, HMIs or GUIs. Furthermore, sensors can only be physically connected to the transmitter. As a result, there are only fixed contents and, e.g., raw sensor values. In addition, these sensor readings are only available to one transmitter at a time. If a sensor is located at a great distance, a long cable will need to be laid. The contents of a plurality of transmitters are only available at the control center, which entails a high configuration effort and infrastructure such as network technology (field buses), etc.

### SUMMARY

In the light of this problem, the present disclosure is based on the object of providing a method that allows the functions of a plurality of transmitters to be combined.

The object is achieved by a system comprising a first transmitter and a second transmitter, wherein one or more first sensors are connected to the first transmitter, wherein the first transmitter is designed to receive and process first data from the first sensors, wherein one or more second sensors are connected to the second transmitter, wherein the second transmitter is designed to receive and process second data from the second sensors, wherein the first transmitter and the second transmitter are in wireless communication with one another. For this reason, the data between the first and second transmitter are explicitly transferred digitally.

According to the present disclosure, it is provided that the first transmitter is designed to transfer at least a portion of the first data to the second transmitter via the communication connection, wherein the second transmitter is designed to output and/or process the transferred first data, and/or

that the second transmitter is designed to transfer at least a portion of the second data to the first transmitter via the communication connection, wherein the first transmitter is designed to output and/or process the transferred second data.

The system according to the present disclosure is characterized by a seamless and wireless linking of two or more transmitters with one another, in order to share measured values across transmitters in the absence of a control center.

The first sensors connected to the first transmitter appear to the user as if they were directly connected to the second transmitter, and vice versa. One transmitter thus forwards the measured values of its sensors to the other transmitter, so that the user can also access data from remote sensors and ideally does not notice that a remote sensor connected to another transmitter is not directly connected to the transmitter operated by the user.

The individual transmitters can still be used independently and continue to function even if the connection is lost, with all the advantages such as logging etc.

Suitable sensors include sensor modules that measure the physical or chemical measured values of a process, such as pH, conductivity, turbidity, oxygen, etc.

According to one embodiment of the system, it is provided that the communication connection established between the transmitters is based on a wireless radio standard, in particular WiFi, Bluetooth or Bluetooth LE. Other suitable wireless standards are also conceivable, as long as they meet certain requirements in terms of range and stability.

Advantageously, it is provided that the first data and/or the second data are measured values of the corresponding first sensors or second sensors, in particular main measured values, secondary measured values or measured values of environmental sensors assigned to the first sensors or second sensors. Environmental sensors are additional sensors that are either integrated directly into the housing of a first or second sensor or are a separate unit that takes the environmental measurements for the measuring point of the corresponding first or second sensor. Measured values from environmental sensors are, for example, values for brightness, temperature, etc.

An advantageous further development of the system provides that the first transmitter, or the second transmitter, comprises a display unit, wherein the display unit of the first transmitter, or of the second transmitter, is designed to output the corresponding transferred first data, or second data, via the display unit. The display unit is a display, in particular an LCD or LED display. In particular, it is provided that the display unit is designed to provide one display region per first sensor or second sensor, via which display regions the corresponding data from the respective first sensor or second sensor are output, wherein the display unit is designed to provide a further display region, via which further display region the transferred data are output.

Sensors that are connected to transmitters are usually displayed on the display unit as so-called “sensor channels.” This means that each sensor is assigned such a channel that displays information about the sensor, e.g. its name, and the current measured values of the sensor. The respective sensor channels are shown in separate display regions of the display unit. Alternatively or additionally, it may be possible to scroll through different views (in each case with one or more sensor channels).

Now it is provided that the first sensors are also displayed as sensor channels on the display unit of the second transmitter, or that the second sensors are also displayed as sensor channels on the display unit of the first transmitter. For the user, the sensors of the respective other transmitter act like the sensors connected to the transmitter whose display unit the user is viewing.

Furthermore, the task is achieved by a method for extending the functionality of a first transmitter, wherein one or more first sensors are connected to the first transmitter, wherein the first transmitter is designed to receive and process first data from the first sensors, characterized in that the method comprises:
providing a second transmitter;
establishing a wireless communication connection with the second transmitter;
transferring at least a portion of the first data from the first transmitter to the second transmitter; and
processing and/or outputting the transferred first data by the second transmitter, in particular outputting by a display unit of the second transmitter.

The first transmitter thus acts as a “sender,” which transfers the first data from one or more of the first sensors connected to the first transmitter. Accordingly, the second transmitter acts as a “listener” or “receiver,” which receives the data from the first transmitter.

“Processing” means, for example, that the transmitter converts raw measured values from sensors into measured values (e.g. by means of the use of a linearization table), or that statistical operations are carried out on the data, such as averaging, etc.

It is advantageously provided that the wireless communication connection is established in a secure, in particular encrypted, manner. For this purpose, cryptographic information (e.g. keys) is exchanged between the transmitters in the course of establishing the communication connection or, for example, a challenge-response procedure is carried out.

An advantageous embodiment of the method provides that a portion of the second data is additionally transferred from the second transmitter to the first transmitter, and that the transferred first data are output and/or processed by the second transmitter. As a result, bidirectional transfer is established. This means that in each case the two transmitters in each case transmit data to the other transmitter.

According to one embodiment of the method, it is provided that, in the course of establishing the communication connection, a user selects which of the transmitters is to transfer the first data, or the second data, to the corresponding other transmitter. The selection of which transmitter will act as the sender and which will act as the “listener” is made directly upon the establishment.

### BRIEF DESCRIPTION OF THE DRAWINGS

The present disclosure is explained in greater detail with reference to the following FIGURE:

FIG. 1 shows a first exemplary embodiment of the system according to the present disclosure.

### DETAILED DESCRIPTION

The system consists of a first transmitter TR1, a second transmitter TR2 and a third transmitter TR3. The transmitters TR1, TR2, TR3 are arranged at a distance from one another. The first transmitter TR1 is arranged at a location remote from the second transmitter TR2, for example at a body of water.

Two first sensors SE1, SE2 are arranged on the first transmitter TR1. The first sensors SE1, SE2 are connected to the first transmitter TR1 by means of a cable connection and measure, for example, the pH value (sensor SE1) and the conductivity (sensor SE2) of a medium. The first transmitter comprises a display unit AE on which the individual first sensors SE1, SE2 are visualized as sensor channels. In particular, it is provided that each sensor channel is assigned its own separate display region on the display unit AE. The display of a sensor channel comprises, for example, the display of the name of the first sensor SE1, SE2 and its current measured values.

The second transmitter TR2 is located close to the system at the user, for example. The transmitter TR2 is a so-called analyzer, which comprises a plurality of second sensors SE1′, SE2′ in its housing, which detect physical or biological measured values of a sample, for example of a water or food sample. The second transmitter also comprises a display unit AE′, on which the individual second sensors SE1′, SE2′ are visualized as sensor channels. In particular, it is provided that each sensor channel is assigned its own separate display region on the display unit AE′. The display of a sensor channel comprises, for example, the display of the name of the second sensor SE1′, SE2′ and its current measured values.

A communication connection KV is established between the two transmitters TR1, TR2, so that the values of the first sensors SE1, SE2 connected to the first transmitter TR1 are also available to the user even when close to the system. For example, “pairing” mode is selected on both transmitters TR1, TR2 via the corresponding operating elements. The two transmitters TR1 and TR2 contact one another via a suitable wireless standard, e.g. Bluetooth, WiFi or via a mobile phone connection, and establish the communication connection KV. Within this framework, the transmitters TR1, TR2 can exchange cryptographic information (e.g. keys) in order to establish a secure communication connection KV.

After or during the establishment of the communication connection KV, the user is asked (e.g. via the display units AE, AE′ on one or both of the transmitters TR1, TR2) which of the two transmitters TR1, TR2 is to act as a sender and which of the two transmitters TR2 is to act as a receiver or “listener.” The user makes an input at one or both of the transmitters TR1, TR2 regarding his choice. It can also be provided that the two transmitters TR1 and TR2 are senders and receivers at the same time.

In the present case, the user selects the first transmitter TR1 as the sender and the second transmitter TR2 as the receiver. The user then selects which data are to be transferred from the first transmitter TR1 to the second transmitter. In the present example, the user selects that the current measured values of the first sensors SE1, SE2 are to be regularly transmitted to the second transmitter TR2. These data are described below as “first data.”

From now on, the first transmitter TR1 regularly transmits the first data to the second transmitter TR2. The second transmitter TR2 receives these first data and interprets them. It recognizes that these are measurement data from a plurality of sensors and treats these measured values as measured values from its own second sensors SE1′, SE2′. This means that it generates a sensor channel for each of the first sensors SE1, SE2 and also visualizes these new sensor channels on the display unit AE′. The values of the first sensors SE1, SE2 can also be processed and, for example, offset against one another (also with measured values from the second sensors SE1′, SE2′). For the user, the first sensors SE1, SE2 on the second transmitter TR2 appear as sensors connected directly to the second transmitter TR2.

It can be provided that sensors “remote from the analysis” can also be used according to the present disclosure, which for example detect a measurement of, for example, a pressure, a radiation or a temperature, etc.

If the second transmitter TR2 is also selected as the sender—and therefore the first transmitter TR1 as the receiver—the sending of the data from the second sensors SE1′ SE2′ is effected and the display of the data from the second sensors SE1′ SE2′ is effected on the display unit AE of the first transmitter TR1 in a similar manner.

It can also be provided that more than two transmitters TR1, TR2 are provided in the system and that one transmitter transmits its data to more than one other transmitter, or that one transmitter receives and outputs the data from more than one other transmitter.

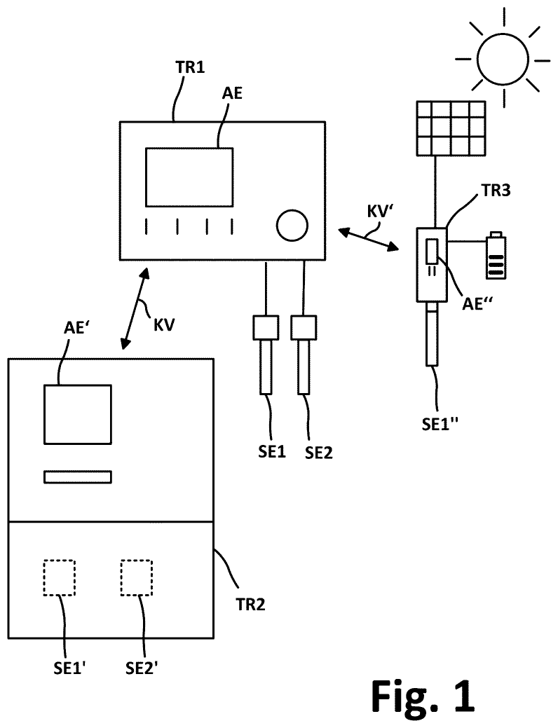

In the present exemplary embodiment shown in FIG. 1, a third transmitter TR3 is provided for this purpose, which is located away from the other two transmitters TR1, TR2, for example at a body of water. A sensor SE1″ is assigned to the third transmitter TR3, which sensor SE1″ detects, for example, a value for the turbidity of the water. The third transmitter TR3 and its sensor SE1″ are supplied with the electrical energy required for operation by means of a solar module or a rechargeable battery. It is also possible that the solar module is designed to charge the battery.

Analogous to the connection according to the present disclosure between the first transmitter TR1 and the second transmitter TR2, a further communication connection KV′ is established between the third transmitter TR3 and the first transmitter TR1. Analogously to the example described above, the third transmitter TR3 can now transmit data, in particular data from its sensor SE1″, to the first transmitter T1 (and vice versa).

1. A measuring system, comprising:
a first transmitter; and
a second transmitter,
wherein one or more first sensors are connected to the first transmitter and the first transmitter is designed to receive and process first data from the one or more first sensors,
wherein one or more second sensors are connected to the second transmitter and the second transmitter is designed to receive and process second data from the one or more second sensors,
wherein the first transmitter and the second transmitter are wirelessly in communication connection with one another,
wherein the first transmitter is designed to transfer at least a portion of the first data to the second transmitter via the communication connection,
wherein the second transmitter is designed to output and/or process the transferred portion of the first data, and/or
wherein the second transmitter is designed to transfer at least a portion of the second data to the first transmitter via the communication connection, and
wherein the first transmitter is designed to output and/or process the transferred portion of the second data.

2. The measuring system according to claim 1, wherein the communication connection is based on a wireless radio standard.

3. The measuring system according to claim 1, wherein the first data and/or the second data are measured values of the corresponding first sensors or second sensors or measured values of environmental sensors assigned to the first sensors or second sensors.

4. The measuring system according to claim 1, wherein the first transmitter or the second transmitter includes a display unit, wherein the display unit of the first transmitter or of the second transmitter is designed to output the corresponding transferred portion of the first data or second data.

5. The measuring system according to claim 4, wherein the display unit is designed to provide one display region per first sensor or second sensor via which display regions the corresponding data of the respective first sensor or second sensor are output, wherein the display unit is designed to provide a further display region via which further display region the transferred data are output.

6. A method for extending a functionality of a first transmitter, wherein one or more first sensors are connected to the first transmitter, wherein the first transmitter is configured to receive and process first data from the first sensors, the method comprising:
providing a second transmitter;
establishing a wireless communication connection with the second transmitter;
transferring at least a portion of the first data from the first transmitter to the second transmitter; and
processing and/or outputting the transferred portion of the first data by the second transmitter.

7. The method according to claim 6, wherein the wireless communication connection is established in a secure manner.

8. The method according to claim 6, further comprising:
transferring a portion of the second data from the second transmitter to the first transmitter; and
outputting and/or processing the transferred portion of the second data by the first transmitter.

9. The method according to claim 8, wherein, in the course of establishing the communication connection, a user selects which of the transmitters is to transfer the first data, or the second data, to the corresponding other transmitter.
